(19) United States
(12) Patent Application Publication
(10) Pub. No.: US 2002/0066516 A1
(43) Pub. Date: Jun. 6, 2002

(54) Mechanism for attaching a lifter to a straw and method therefor

(76) Inventor: Stephen W. Cornell, Naperville, IL (US)

Correspondence Address: Harness, Dickey & Pierce, P.L.C., P. O. Box 828, Bloomfield Hills, MI, 48303, US

(21) Appl. No.: 09/727,848

(22) Filed: Dec. 1, 2000

(51) Int. Cl. B32B 31/00

(52) U.S. Cl. 156/64; 156/303.1; 156/293; 156/295

(57) ABSTRACT

A method for automatically attaching a lifter to a straw feeds a single straw from a supply of straws and feeds a single lifter from a supply of lifters. The straw is aligned with an aperture in the lifter and the two pieces are assembled to provide a straw assembly. A glue dispenser deposits a quantity of adhesive on the straw and the adhesive is spread between the lifter and the straw to retain the lifter on the straw. In addition to the method described above, an apparatus is described which performs this operation.

### FIELD OF THE INVENTION

The present invention relates to a method and apparatus for positioning and retaining a lifter on a straw. More particularly, the present invention relates to a method and apparatus for automatic high speed assembly and retention of lifters on straws.

### BACKGROUND OF THE INVENTION

Various designs have been proposed in the prior art for placing a straw within a beverage container. The straw is designed to become accessible to the user when the beverage container is opened. One prior art design relies upon user manipulation to align the straw with the container opening, other prior art designs have the straw pre-aligned with the container opening and still other prior art designs include some type of mechanism that aligns the straw with the container opening upon opening of the container.

While all of these prior art designs include various methods of aligning the straw with the container opening, they all rely on the buoyancy of the straw within the liquid filled container to propel the straw from the container through the container opening. The straws can be manufactured from a buoyant material, an integrally formed lifter can be incorporated with the straw or an auxiliary lifter can be assembled to the straw to enhance the buoyancy of the straw to ensure it will be propelled through the container opening.

Soda pop and other liquid filled containers are typically processed on a high-speed filling line in order to meet the demand for the product. Thus, when inserting a straw system within these containers, the straw system must also be inserted at a high rate of speed. When the straw system includes a straw with an auxiliary lifter, the lifter and straw will also need to be assembled at a high rate of speed.

### SUMMARY OF THE INVENTION

The present invention provides the art with a high speed assembly method and mechanism for assembling and retaining a lifter onto a straw. The system is designed to automatically position a lifter on a straw, add a gluing agent, evenly distribute the gluing agent and engage the lifter with the gluing agent. The system is designed to operate in conjunction with a straw insertion system which in turn is designed to operate in conjunction with a high speed filling system.

Other advantages and objects of the present invention will become apparent to those skilled in the art from the subsequent detailed description, appended claims and drawings.

### BRIEF DESCRIPTION OF THE DRAWINGS

In the drawings which illustrate the best mode presently contemplated for carrying out the present invention:

FIG. 1 is a side view of a straw and lifer which is to be inserted into a container;

FIG. 2 is a side view of a mechanism which inserts the straw into the container in accordance with the present invention;

FIG. 3 is a top view of the mechanism shown in FIG. 2;

FIG. 4 is an enlarged view of the straw feeding system shown in FIG. 2;

FIG. 5 is an enlarged view of the lifter feeding system shown in FIG. 2;

FIG. 6 is an enlarged view of the initial positioning system shown in FIG. 2;

FIG. 7 is an enlarged view of the gluing and final positioning system shown in FIG. 2;

FIG. 8 is a top view of a mechanism which is designed to install a lifter onto a straw in accordance with another embodiment of the present invention;

FIG. 9 is a side view of the mechanism shown in FIG. 8; and

FIG. 10 is an enlarged plan view of one of the carriages shown in FIG. 8.

### DETAILED DESCRIPTION OF THE PREFERRED EMBODIMENT

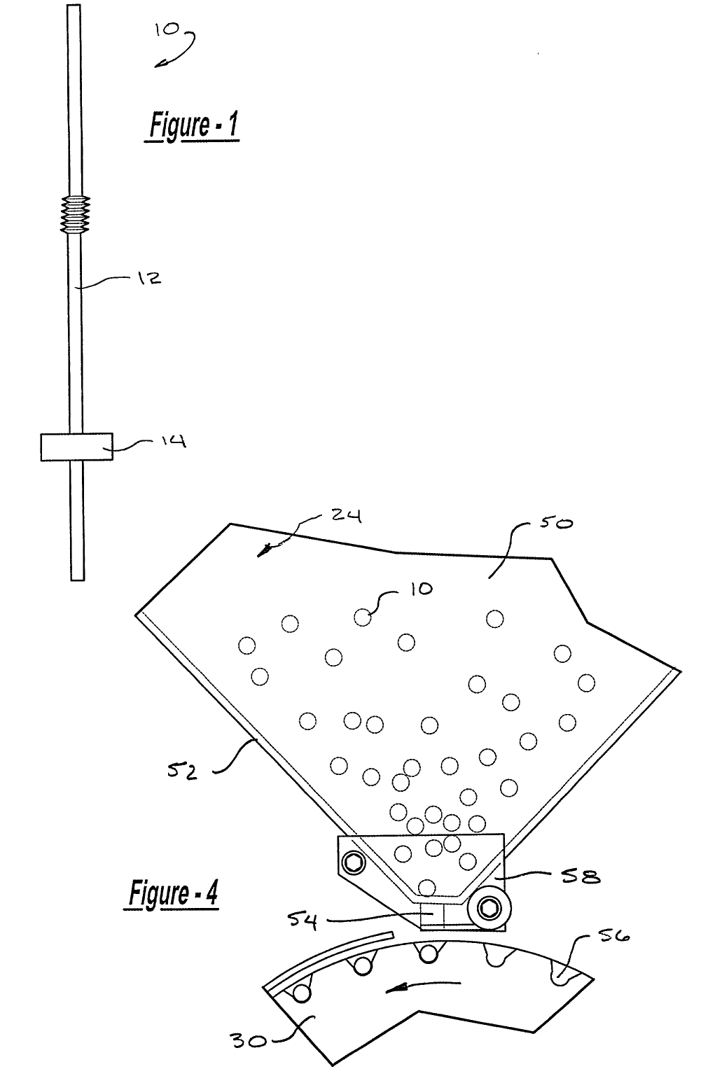

Referring now to the drawings in which like reference numerals designate like or corresponding parts throughout the several views, there is shown in FIG. 1 a straw assembly which is designed to be inserted into a container in accordance with the present invention and which is designated by the reference numeral 10. Straw assembly 10 comprises a straw 12 and a lifter 14. Lifter 14 is secured to straw 12 in order to enhance the buoyancy of straw 12. The position for lifter 14 on straw 12 will be dictated by the clearance necessary to effectively operate with the respective straw delivery system which delivers straw assembly 10.

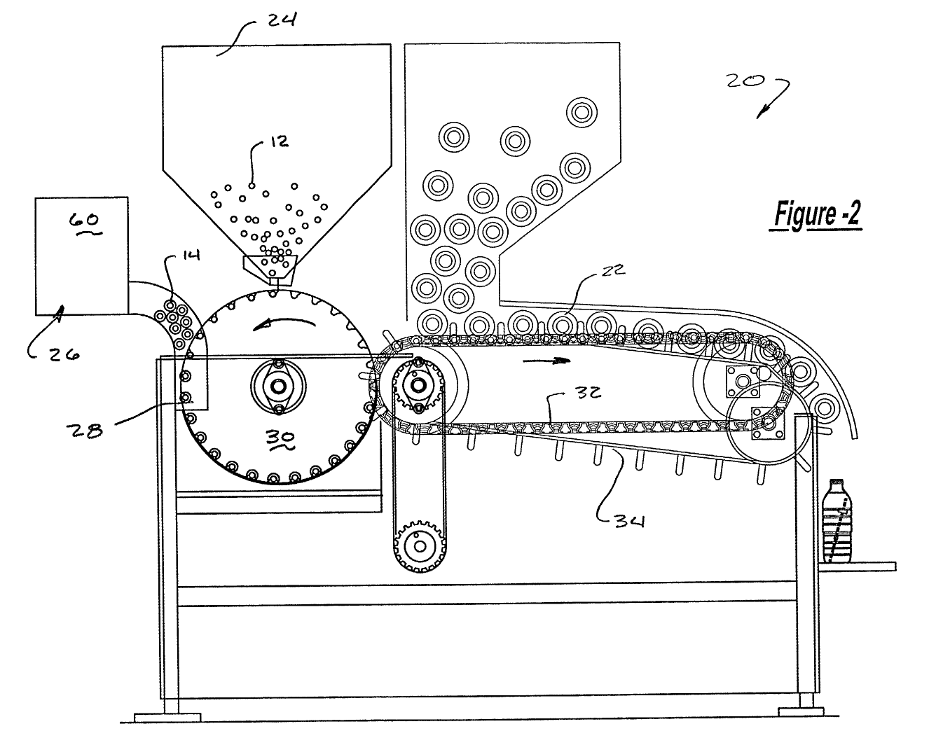

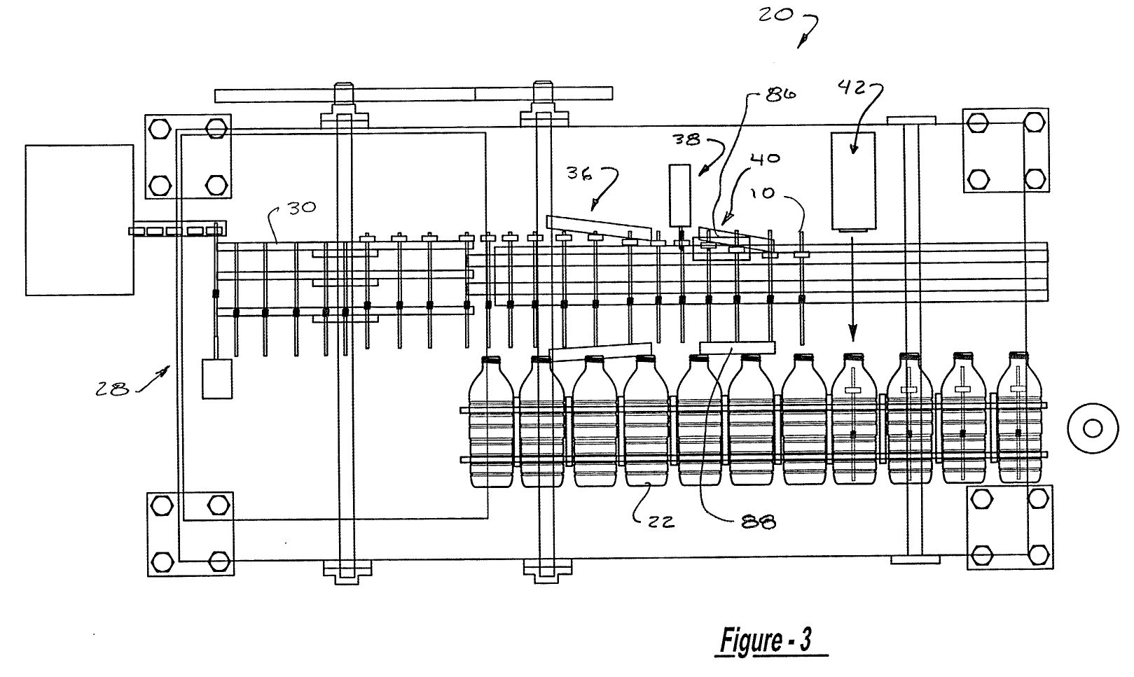

Referring now to FIGS. 2 and 3, a mechanism 20 for assembling a respective straw assembly 10 into each of a plurality of containers 22 is disclosed. Mechanism 20 comprises a hopper 24, a vibratory or centrifugal feeder 26, a lifter assembly mechanism 28, a lifter assembly wheel 30, a feeding track 32, a feeding track 34, a positioning system 36, a gluing or adhesive system 38, a final positioning system 40, and an insertion system 42.

Mechanism 20 is designed for high speed insertion of straw assembly 10 into each of containers 22. In general, hopper 24 is filled with a plurality of straws 12 and feeder 26 is filled with a plurality of lifters 14. Straws 12 are fed to lifter assembly wheel 30 which positions each straw 12 in line with a respective lifter 14 where it is assembled onto straw 12 by mechanism 28. Wheel 30 feeds straw assembly 10 to track 32. As each straw assembly moves down track 32, positioning system 36 initially locates lifter 14 on straw 12, gluing system 38 dispenses a specified amount of glue and final positioning system 40 engages straw 12 and lifter 14 to position lifter 14 in its final position while rotating either straw 12 or lifter 14 to spread the glue evenly. Once the final position of lifter 14 on straw 12 is achieved, feeding track 32 aligns straw assembly 10 with an opening in a respective container 22 which is fed to a position adjacent feeding track 32 by feeding track 34. At this point, insertion system 42 inserts straw assembly 10 within container 22, container 22 is rotated to a generally vertical position to be transferred to a system which retains straw assembly 10 within container 22.

The present invention is directed to the unique high speed system for securing lifter 14 onto straw 12 in the proper position as shown in FIGS. 4-8. FIG. 4 illustrates hopper 24 and the feeding of straws 12 to lifter assembly wheel 30. Hopper 24 comprises an open container 50 which includes a funnel like section 52 which leads to an opening 54 through which a single straw 12 is allowed to pass. Hopper 24 can be a vibratory feeding hopper if improvement in the feeding of straws 12 is required. As wheel 30 rotates in a counterclockwise direction, each of a plurality of pockets 56 align with opening 54. A feeding mechanism 58 releases one straw 12 which is then picked up by the open pocket 56 to move straw 12 counterclockwise with wheel 30. As wheel 30 continues to rotate, each pocket 56 with its associated straw 12 engages feeder 26 and lifter mechanism 28.

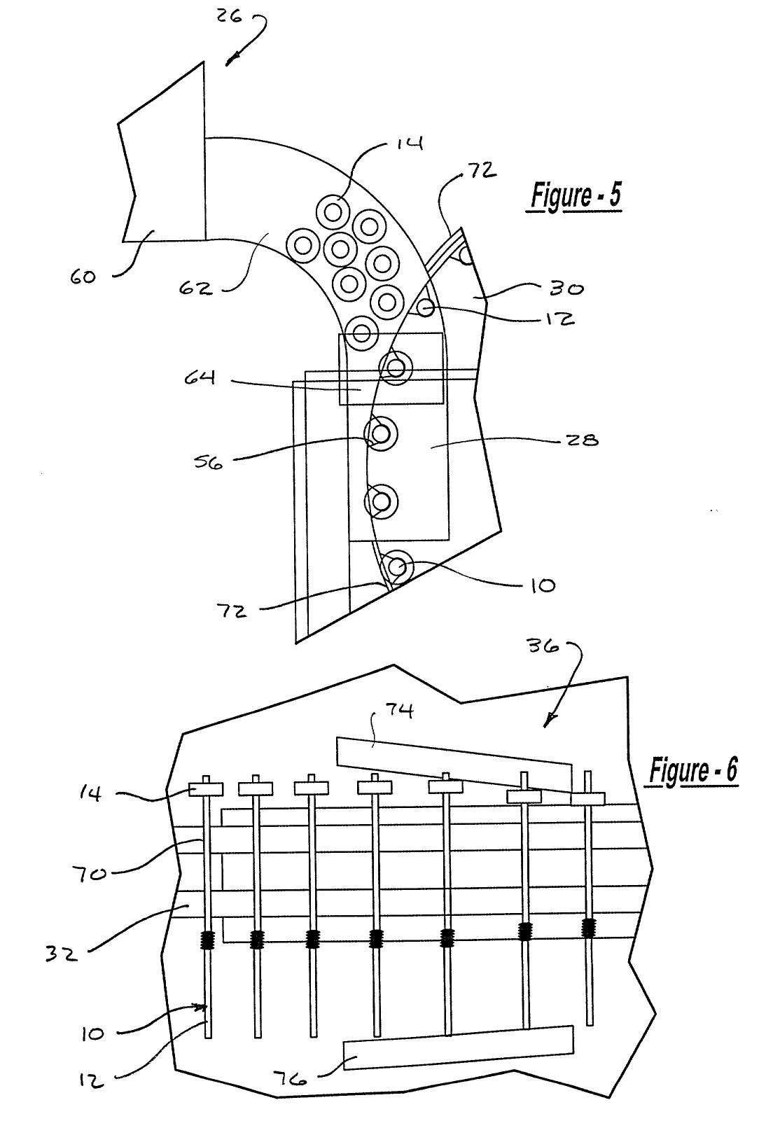

Referring to FIG. 5, feeder 26 includes a bowl 60 within which a plurality of lifters 14 are stored. Bowl 60 is a vibratory or centrifugal feeding bowl which, when activated, feeds lifters 14 in a proper orientation to a track member 62. Track member 62 curves to a position adjacent wheel 30 such that the lifter 14 at the end of track member 62 is positioned at a radial distance with respect to wheel 30 to be aligned with the radial position of pockets 56 in wheel 30. As wheel 30 rotates, a sensing system 64 determines when a respective straw 12 within one of the pockets 56 is aligned with an aperture extending through lifter 14. At the time of alignment, lifter assembly mechanism 28 is actuated to push straw 12 through the hole in lifter 14 while simultaneously releasing lifter 14 from track member 62. As wheel 30 continues to rotate, straw assembly 10 (straw 12 and lifter 14) travel counterclockwise with wheel 30 in each of the respective pockets 56.

As wheel 30 continues to rotate, each of straw assemblies 10 are fed to a respective pocket 70 in positioning track 32. While straws 12 and straw assemblies 10 rotate within pockets 56 of wheel 30, a guard system 72 ensures that straws 12 and straw assemblies 10 are kept within pockets 56 until engagement with positioning track 32 where straw assemblies 10 are fed to pockets 70.

Referring to FIG. 6, positioning track 32 moves straw assemblies 10 horizontally as shown in FIGS. 2 and 3 and eventually feeds each straw assembly 10 adjacent to feeding track 34. As straw assemblies 10 are moved along positioning track 32, they engage positioning system 36 which includes a pair of positioning members 74 and 76. Positioning members 74 and 76 are angled with respect to track 32 to form a funnel shaped positioning system that accurately locates each lifter 14 onto its respective straw 12. The accurate positioning of lifter 14 on straw 12 is needed for the gluing operation described below. After initial positioning of lifter 14 by positioning members 74 and 76, straw assemblies 10 continue along track 32 until they are engaged by gluing system 38. While the present invention is being described having positioning members 74 and 76 for positioning lifter 18, it is within the scope of the present invention to utilize other positioning devices known in the art for locating lifter 18.

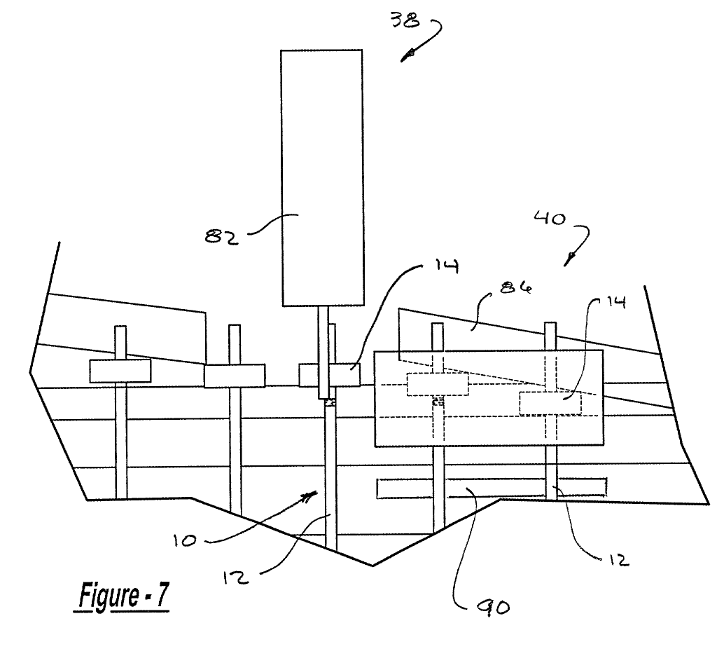

Straw assemblies 10 proceed horizontally as shown in FIGS. 2 and 3 and eventually engage gluing system 38 as shown in FIG. 7. Gluing system 38 comprises a glue dispenser 82 which deposits a specified amount of glue in the corner formed by straw 12 and lifter 14. After the glue has been positioned on straw assembly 10, continued movement of feeding track 32 delivers each straw assembly 10 to final positioning system 40.

Referring to FIGS. 2 and 7, final positioning system 40 includes a pair of positioning members 86 and 88 which are designed to move lifter 14 on straw 12 in the direction towards the glue deposit. Thus, final positioning of lifter 14 can be accomplished by pushing lifter 14 further on straw 12 or by pushing lifter 14 opposite to the original direction of assembly. Regardless of which direction lifter 14 is moved to place it in its final position, glue dispenser 82 deposits the glue in the appropriate corner. In order to ensure a complete distribution of the glue between lifter 14 and straw 12, final positioning system 40 includes a mechanism 90 which rotates straw 12 during the final positioning move of lifter 14 to provide means for spreading the glue on straw 12. While final positioning system 40 utilizes mechanism 90 for rotating straw 12, it is within the scope of the present invention to rotate lifter 14 during the final positioning move if desired. The moving of lifter 14 in the direction of the glue and the rotational motion provides means for spreading the glue or adhesive on straw 12. While the present invention utilizes lifter 14 as means for spreading the glue or adhesive, it is within the scope of the present invention to use brushes, sprays, spreaders or the like to spread the glue on straw 12. While the present invention is being described having positioning plates 86 and 88 for positioning lifter 18, it is within the scope of the present invention to utilize other positioning devices known in the art for locating lifter 18.

Once final positioning system 40 has properly positioned lifter 14, continued movement of feeding track 32 delivers each straw assembly 10 to a position adjacent feeding track 34 which aligns each straw assembly 10 with an opening in a respective container 22 and deposits a single straw assembly 10 within each container 22. Track 34 then continues the horizontal movement of containers 22 with straw assemblies 10 until a rotation mechanism positions containers 22 vertically in order to feed them to a system which retains straw assembly 10 within container 22.

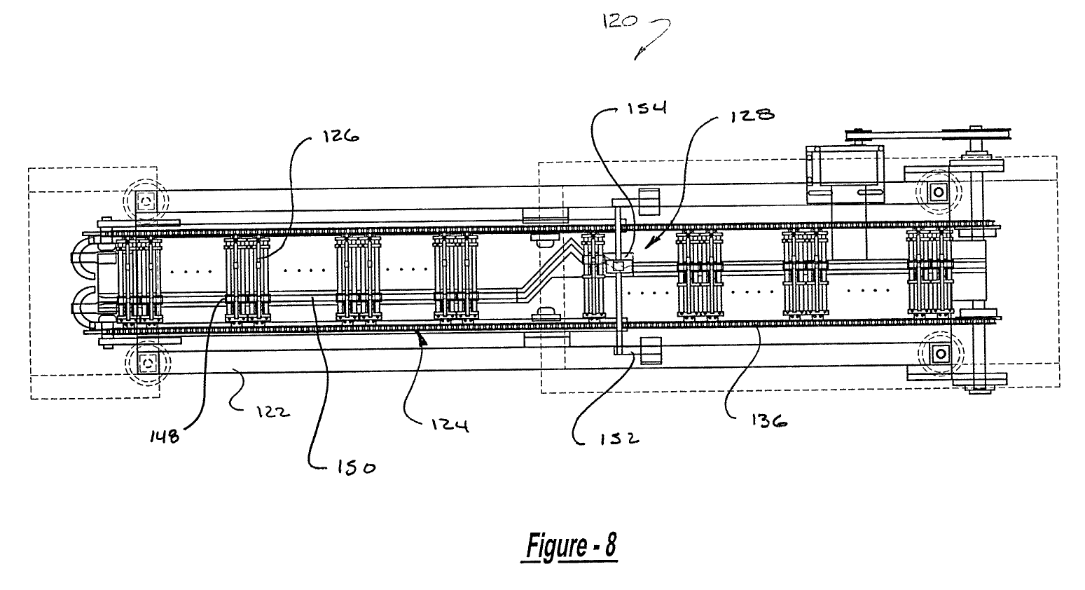

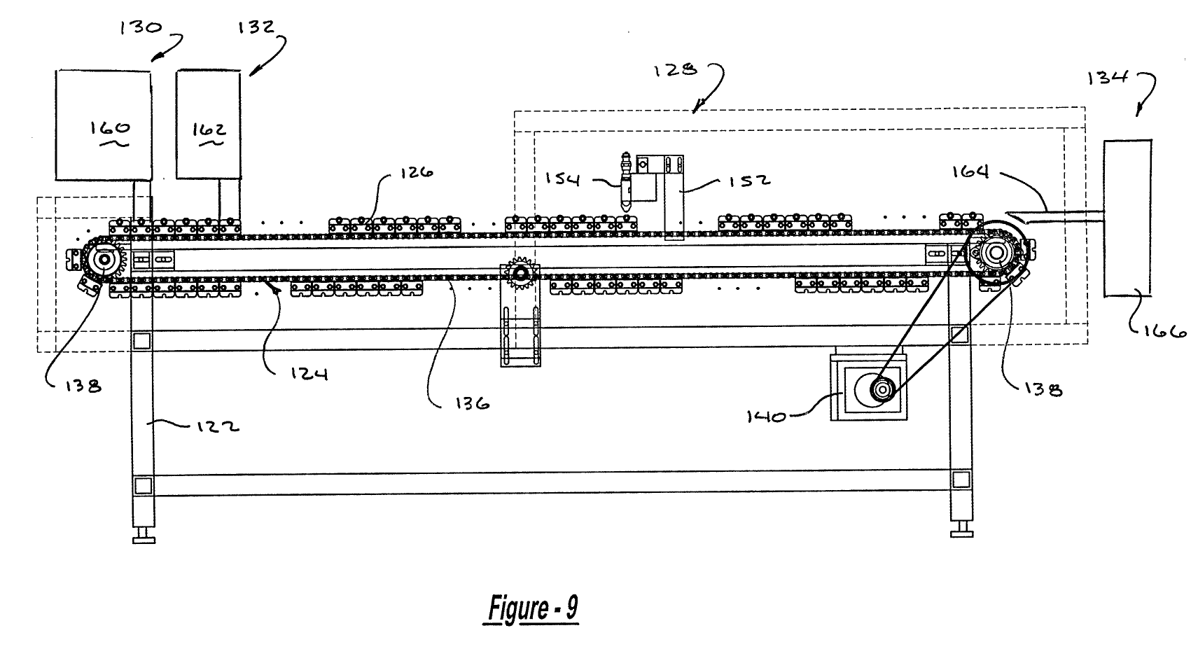

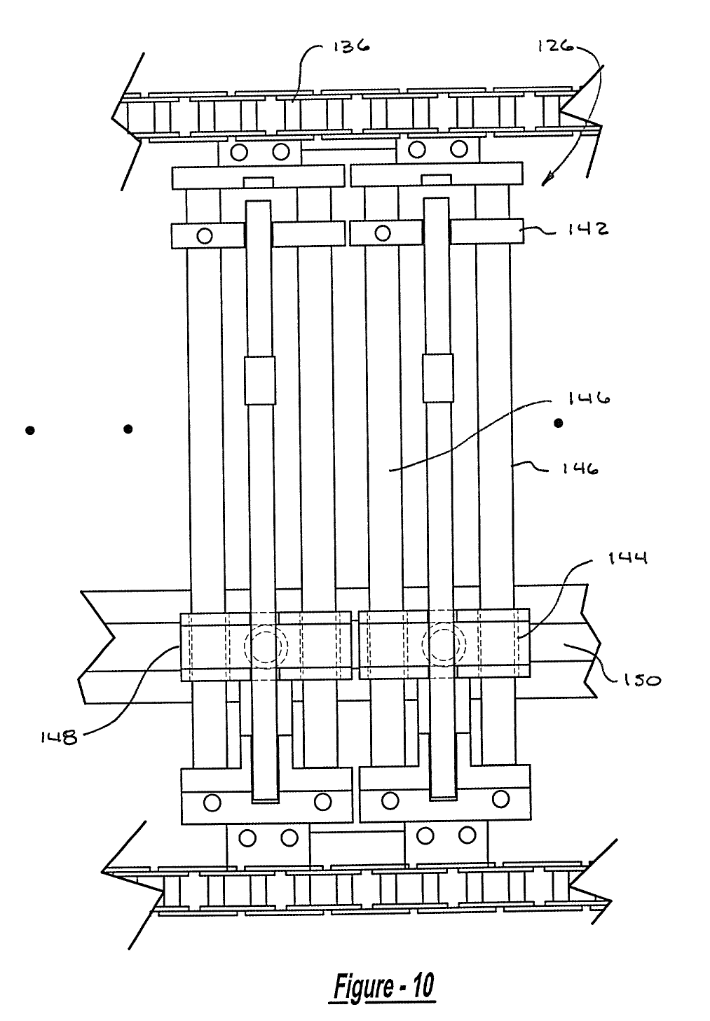

Referring now to FIGS. 8-10, a mechanism 120 for assembling lifter 14 onto straw 10 in accordance with another embodiment of the present invention is disclosed. Mechanism 120 comprises a support structure 122, a chain feeding system 124, a plurality of carriages 126, a glue applicator 128, a straw feeding system 130, a lifter feeding system 132 and an outfeeding system 134.

Support structure 122 supports the remaining components of mechanism 120 at an appropriate level above a plant floor. Chain feeding system 124 includes an endless chain 136 that runs between a pair of pulleys 138 and which is powered by a drive system 140. Drive system 140 provides continuous movement of chain 136 between pulleys 138.

Carriages 126 are secured to chain 136 and move with chain 136 as it moves between pulley 138. Each carriage 126 includes a straw support 142 and a lifter support 144 that moves axially along a pair of slides 146 extending longitudinally across carriage 126. Straw support 142 is adapted to support a single straw 12 and lifter support 144 is adapted to support a single lifter 14. Each carriage 126 also includes a cam follower 148 which engages a cam track 150 to move lifter support 144 and thus lifter 14 axially along slides 146 as chain 136 moves between pulleys 138 as detailed below. Glue applicator 128 is supported above chain 136 and carriages 126 by a support structure 152. Support structure 152 positions a glue gun 154 longitudinally between the ends of carriages 126 and is positioned to place a prespecified quantity of glue at a prespecified position on each straw 12 positioned on straw supports 142 of carriages 126, as also described below.

Straw feeding system 130 includes a vibratory feeder or hopper 160 which positions a single straw 12 into each straw support 142 of carriage 126. Vibratory feeder or hopper 160 is designed to orient each straw 12 by placing the pleated section of each straw 12 at a specified side of carriage 126 prior to the placement of straw 12 into straw support 142.

Lifter feeding system 132 also includes a vibratory feeder or hopper 162 which positions a single lifter 14 into each lifter support 144 of carriage 126. Lifter support 144 and straw support 142 are designed such that the center hole in lifter 14 is in registry with straw 12. Thus, when lifter support 144 is moved longitudinally with respect to straw support 142 and straw 12, lifter 14 will engage straw 12 to assemble lifter 14 onto straw 12. The design for lifter 14 is illustrated as being symmetrical and thus there is no need to correctly orient each lifter 14 in a side to side manner. It is within the scope of the present invention to properly orient a non-symmetrical lifter 14 using vibratory feeder or hopper 162 if desired.

Outfeeding system 134 is designed to receive each straw assembly 10 from its respective carriage 126, move each straw assembly 10 from a horizontal position to a vertical position and then transport straw assemblies 10 to containers 22 which are designed to accept a single straw assembly 22. Outfeeding system 134 includes an orientation device 164 and a transportation conveyor 166. Orientation device 164 relies on the position of the center of gravity for straw assembly 10 to move it from a horizontal position to a vertical position. After the assembly of lifter 14 to straw 12, the center of gravity of the assembly is closer to one end because lifter 14 is positioned closer to one end. Orientation device 164 relies on this off center position of the center of gravity for straw assembly 10 and gravity to cause straw assembly 10 to properly orient itself as it moves through orientation device 164. Orientation device 164 feeds straw assemblies 10 to transportation conveyor 166 which moves them to the bottle assembly area by gravity or by vibratory feeding.

The sequence of operation for mechanism 120 is to have straw feeding system 130 feed a single straw 12 to a respective straw support 142 of carriage 126. A single lifter 14 is fed by lifter feeding system 132 to a respective lifter support 144 before, after or simultaneously with straw 12. Chain 136 moves carriage 126 with straw 12 and lifter 14 along support structure 122 until cam follower 148 engages cam track 150 to move lifter support 144 longitudinally along carriage 126 to assemble lifter 14 to straw 12. As shown in FIG. 8, cam track 150 is designed to push lifter 14 onto straw 12 and along straw 12 to a position beyond its final position where glue gun 154 dispenses a prespecified amount of glue or adhesive onto straw 12. Cam track 150 then pushes lifter support 114 and thus float 14 onto the dispensed glue such that the glue is now located between flat 14 and straw 12. The purpose for pushing lifter past its final position and then bringing it back over the glue is to ensure that any bead of glue or adhesive which is left at the interface of lifter 14 and straw 12 will be at the bottom of lifter 14 after straw assembly 10 is inserted into container 22. It is within the scope of the present invention to design cam track 150 to move and thus position lifter 14 anywhere along straw 12 if desired. After the gluing operation, straw assembly 10 continues along support structure 122 with chain 136 until it encounters outfeeding system 134 which transfers straw assembly 10 from carriage 126 to a vertical position in line to be inserted into container 22.

While the above detailed description describes the preferred embodiment of the present invention, it should be understood that the present invention is susceptible to modification, variation and alteration without deviating from the scope and fair meaning of the subjoined claims.

What is claimed is:

1. A method of automatically assembling a lifter to a straw, the method comprising the steps of:
providing a plurality of said straws;
providing a plurality of said lifters;
aligning an aperture in at least one of said plurality of lifters with each of a procession of said straws;
engaging said at least one lifter with each of said procession of straws; and
positioning said at least one lifter at a first specified position on each of said processing of straws.

2. The method according to claim 1, further comprising dispensing a quantity of adhesive onto each of said procession of straws.

3. The method according to claim 2, further comprising the step of spreading said quantity of adhesive on each of said procession of straws.

4. The method according to claim 3, wherein the step of spreading said quantity of adhesive includes the step of positioning said at least one lifter at a second specified position.

5. The method according to claim 4, wherein the step of spreading said quantity of adhesive includes the step of rotating one of said at least one lifter and each of said procession of straws with respect to the other of said at least one lifter and each of said procession of straws.

6. The method according to claim 1, further comprising the step of positioning said at least one lifter at a second specified position on each of said procession of straws.

7. The method according to claim 6, further comprising dispensing a quantity of adhesive onto each of said procession of straws.

8. The method according to claim 7, further comprising the step of spreading said quantity of adhesive on each of said procession of straws.

9. The method according to claim 8, wherein the step of spreading said quantity of adhesive includes the step of positioning said at least one lifter at a third specified position.

10. The method according to claim 9, wherein the step of spreading said quantity of adhesive includes the step of rotating one of said at least one lifter and each of said procession of straws with respect to the other of said at least one lifter and each of said procession of straws.

11. An apparatus for automatically assembling a lifter onto a straw, said apparatus comprising:
a straw feeding system for feeding said straw from a plurality of straws;
a lifter feeding system for feeding said lifter from a plurality of lifters, said lifter feeding system in conjunction with said straw feeding system being operable to align said straw with an aperture in said lifter;
an assembly device for engaging said straw with said aperture in said lifter; and
a positioning mechanism for locating said lifter at a first specified position on said straw.

12. The apparatus according to claim 11, further comprising an adhesive dispenser for dispensing a quantity of adhesive onto said straw.

13. The apparatus according to claim 12, further comprising means for spreading said adhesive on said straw.

14. The apparatus according to claim 13, wherein the means for spreading said adhesive on said straw includes the position of said lifter at a second specified position.

15. The apparatus according to claim 14, wherein the means for spreading said adhesive on said straw includes a mechanism for causing rotational movement between said straw and said lifter.
